(19) United States
(12) Patent Application Publication
(10) Pub. No.: US 2025/0183766 A1
(43) Pub. Date: Jun. 5, 2025

(54) STATOR CONTROL SYSTEM

(71) Applicant: SAFRAN ELECTRICAL & POWER, Pitstone Buckinghamshire (GB)

(72) Inventor: Paul David FLOWER, Pitstone Buckinghamshire (GB)

(21) Appl. No.: 18/841,074

(22) PCT Filed: Feb. 22, 2023
(86) PCT No.: PCT/GB2023/050396

§ 371 Date: Aug. 23, 2024

(30) Foreign Application Priority Data
Feb. 24, 2022 (GB) 2202526.6

(51) Int. Cl. H02K 11/27; H02P 29/024

(52) U.S. Cl. CPC H02K 11/27; H02P 29/024

(57) ABSTRACT

A multi-phase electrical machine for use in an aircraft. The electrical machine includes a stator including a plurality of electrical phases. Each electrical phase includes phase windings. The phase windings in each phase having a first end electrically connected to a common neutral conductor, and a second end providing an electrical connection from the phase winding to an electrical power source or load. The electrical machine also including an array of magnetic elements, the rotor being rotatably mounted with respect to the stator. The electrical machine also including sensing means configured to sense a condition of the stator indicative of an electrical fault in one of the plurality of electrical phases; and at least one electrical interrupter operable to electrically disconnect at least one first end of the plurality of phase windings from the common neutral conductor.

### TECHNICAL FIELD

The present invention relates to an electrical generator comprising a control system configured to detect and isolate an electrical fault.

### BACKGROUND

An electrical machine, either a motor or a generator, generally comprises a rotor assembly configured to rotate on a shaft within a bore of a stationary stator assembly comprising a plurality of windings. An airgap is provided between the rotor assembly and the stator assembly. The interaction of the magnetic fields of the respective rotor and stator assemblies converts electrical energy to mechanical energy in a motor, or mechanical energy to electrical energy in a generator.

Electric machines may sometimes be subject to a fault. For example, a short circuit condition may occur, in particular within windings of the machine. In such conditions, an electric current flows down an unintended path with little electrical resistance, causing an excessive current flow through the unintended path. To limit the impact of such a fault, a means of limiting a flow of current in the event of a short-circuit may be provided. This can inhibit further current generation within the electric machine and can help to protect the windings from further damage, however known solutions tend to limit further useful operation of the electrical machine.

Improvements in fault management means for electric generators are required.

### SUMMARY OF THE INVENTION

According to a first aspect of the invention, there is provided a multi-phase electrical machine for use in an aircraft, the electrical machine comprising: a stator comprising a plurality of electrical phases, each electrical phase comprising phase windings, the phase windings in each phase having a first end electrically connected to a common neutral conductor, and a second end providing an electrical connection from the phase winding to an electrical power source or load; a rotor comprising an array of magnetic elements, the rotor being rotatably mounted with respect to the stator; sensing means configured to sense a condition of the stator indicative of an electrical fault in one of the plurality of electrical phases; and at least one electrical interrupter operable to electrically disconnect at least one first end of the plurality of phase windings from the common neutral conductor.

The invention provides an improved generator in which a short circuit in one winding or set of windings, which may be one channel in a multi-channel machine, one phase in a multi-phase machine, or one star in a multi-star machine, is isolated sufficiently effectively that the machine can continue to operate to generate electrical power in the remaining channels or phases, with those channels or phases being able to continue in operation without having to be also shut down.

The arrangement is particularly beneficial in generators having a rotor comprising permanent magnets. However, it can also improve the speed and effectiveness of isolation of a fault, and can help facilitate continued operation of the generator, in a generator having non-permanent magnets, such as electrical windings, on the rotor.

It will be understood that an “electrical interrupter” is a device configured to break an electric circuit in the event of a fault. This may comprise a fuse, a switch, a circuit breaker, or any other suitable component.

The electrical machine may comprise at least one electrical interrupter operable to electrically disconnect at least one second end of the plurality of phase windings from an external input or output of the electrical machine.

The fault detection means and the at least one electrical interrupter may be connected to a control arrangement, the control arrangement being configured to operate the at least one electrical interrupter upon sensing of a fault in one of the plurality of electrical phases by the sensing means.

This provides an arrangement which responds to faults automatically, in a manner which allows channels operating without faults to continue to operate. By disconnecting channels with a fault, the likelihood that the fault would propagate to a channel operating without faults is significantly reduced.

At least one electrical interrupter may be operable such that the electrical interrupter can both: electrically disconnect at least one first end of the plurality of phase windings from the common neutral conductor; and electrically disconnect at least one second end of the plurality of phase windings from an external input or output of the electrical machine.

With this arrangement, the corresponding phase of windings can be disconnected from both the neutral conductor and the output of the windings. This prevents the propagation of the fault from taking place at either end of the phase.

The at least one electrical interrupter may be an electromechanical device configured to mechanically break the circuit in response to an electrical signal.

The at least one electrical interrupter may comprise a sacrificial part.

This provides an electrical interrupter which is configured to inhibit the flow of further current through the corresponding phase of windings until it is next serviced. Advantageously, the likelihood of unintended re-closure is significantly reduced as a sacrificial interrupter would need to be replaced for said phase of windings to operate as intended.

Each phase of the electrical machine may comprise at least one electrical interrupter.

In this way, each phase of the windings comprises an interrupter and may be disconnected in event of a fault.

The electrical machine may comprise a plurality of electrical interrupters arranged such that the windings of each phase can be disconnected from both the common neutral conductor and the electrical input or output of the electrical machine independently of the other phases.

By each phase being able to be disconnected independently of the other phases, phases without faults may be able to continue to operate and provide power via the output of the generator.

At least one first electrical interrupter may be configured to electrically disconnect at least one first end of the windings in at least one phase from the common neutral conductor, and at least one second electrical interrupter is configured to disconnect at least one second end of the windings in at least one phase from the electrical input or output of the electrical machine.

Advantageously, with this configuration, it is possible to disconnect both the first end and the second end of at least one phase.

The at least one electrical interrupter of each phase may be configured to simultaneously electrically disconnect at least one first end of the windings in the at least one phase from the common neutral conductor, and at least one second end of the windings in the at least one phase from the electrical input or output of the electrical machine.

With this configuration, it possible to use a single electrical interrupter to disconnect both the first end and the second end of the at least one phase, upon detection of a single fault. This can save space and reduce the overall weight of the electrical machine.

The sensing means may be configured to detect a difference in current between the first end and the second end of windings in a phase.

The sensing means and/or the electrical interrupter may comprise a current transformer.

The stator may comprise a plurality of mechanically discrete stator sections, each mechanically discrete stator section having at least one winding.

Each mechanically discrete stator section may comprise windings of a single star.

According to a second aspect of the invention, there is provided an aircraft comprising the generator according to the first aspect of the invention.

### BRIEF DESCRIPTION OF THE DRAWINGS

Further features and advantages of the present invention will be further described below, by way of example only, with reference to the accompanying drawings in which:

FIG. 1 is a schematic illustration of an aircraft comprising an electrical system;

FIG. 2 is an illustration of an electrical circuit for the stator comprising part of the electrical system of FIG. 1;

FIG. 3 is a cross-sectional schematic illustration of the stator comprising part of the electrical machine of FIG. 2;

FIG. 4 is a perspective view of a measuring means for use in the stator of FIG. 3;

FIG. 5 is a schematic cross-sectional view of an electrical interrupter for use in the stator of FIG. 3.

### DETAILED DESCRIPTION

In aircraft, and in electric vertical take-off and landing (eVTOL) aircraft in particular, there is a need for power generation systems that are fault-tolerant per channel or electrical phase. It is possible to meet this need by having a single electrical machine per electrical channel, however this arrangement significantly increases weight and, in turn, can reduce fuel economy and range. It can therefore be desirable to use a single electrical machine with multiple channels. In a multi-channel or multi-phase machine, the stated requirement means that a fault in one phase or channel of a multi-phase or multi-channel generator must not prevent the continued operation of the other phases or channels.

The use of permanent magnets in generators make them such that the magnetic field of the stator cannot be deactivated simply by halting the supply of current. As such, a channel with a fault cannot simply be deactivated, and methods of deactivating channels with faults therein can therefore be more complicated to execute in permanent magnet machines. However, permanent magnet generators generally require less maintenance over their service life and are more lightweight than alternating current alternators, having rotor windings. This presents advantages which make the use of permanent magnets favourable. In devising the disclosed arrangement, the inventor has found an improved way to provide an electrical machine with enhanced redundancy, which can permit the isolation of a fault while allowing the continued operation of the machine.

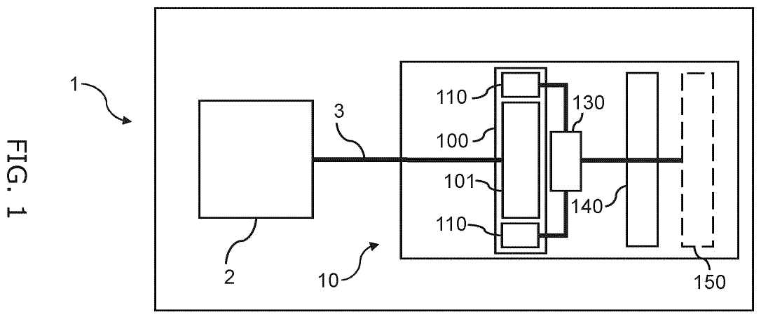

To set out a use case of the present disclosure, as shown schematically in FIG. 1, there is provided an aircraft 1. The aircraft 1 comprises a prime mover 2 configured to provide input motion to a generator 100, and which may also provide direct motive power to propel the aircraft. The prime mover 2 may comprise a gas turbine engine or ducted fan, for example. In the arrangement illustrated, the prime mover 2 comprises a gas turbine engine. The gas turbine engine 2 comprises a shaft 3 which is driven by a turbine of the gas turbine engine 2.

The aircraft 1 further comprises an electrical system 10 comprising an electric machine 100 which may be arranged as a generator configured to deliver power to accessories of the aircraft 1, and/or to provide motive power to a propulsion system of the aircraft, such as one or more propellers. In the arrangement illustrated, the electric machine 100 comprises a permanent magnet generator (herein referred to as a “PMG” 100). Generally, known PMGs comprise a rotor 101 and a stator 110. The stator 110 is typically configured as an annular member comprising a bore (not shown) while the rotor 101 is generally cylindrical in geometry. The rotor 101, ordinarily being arranged concentrically within the bore of the stator 110, is generally rotatably mounted on a shaft (not shown) defining an axis of rotation.

In a PMG 100, the rotor 101 is typically configured to carry a plurality of permanent magnets (not shown). It will be understood that a permanent magnet is an object made from a material that is magnetised and creates its own persistent magnetic field and retains its magnetic properties in the absence of an inducing field or current. Permanent magnets may be accommodated in slots in the body of the rotor 101 which are dimensioned to retain the plurality of permanent magnets. The plurality of permanent magnets therefore collectively propagate a magnetic field of the rotor.

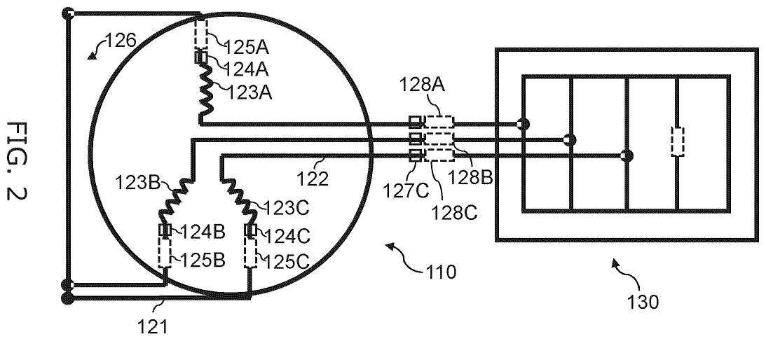

The stator 110 of a PMG 100 generally comprises a plurality of electrical conductors further explained with reference to FIG. 2. As the rotor 101 is rotated about the axis of rotation within the bore of stator 110, the magnetic field of the rotor 101 is also rotated. This causes a rotating magnetic field which interacts with the electrical conductors and thus generates a voltage with the electrical conductors in a usual manner for a known PMG.

The voltage induced within the electrical conductors of the stator 110 may subsequently be used to power various components of the aircraft by providing them with a current. The current generated by the PMG 100 is an alternating current. Specifically, the current within a single conductor (assuming a constant load) varies substantially sinusoidally with time. It can therefore be advantageous to provide multiple phases and/or stars for the conductors, to yield benefits ranging from a more efficient overall output of power as compared to a single-phase machine, to an increased level of redundancy within the multiple phases, so that other phases in the machine can provide a reduced overall power output in the event that one phase should experience a fault requiring its deactivation.

While an alternating current (“AC”) is generated by the PMG 100, the various components which may be provided with a current by the PMG 100 are may require a direct current (“DC”) power supply. For this purpose, the electrical system 1 may comprise an AC to DC power converter 130. The AC to DC power converter 130 may be a one-way power converter. In the example depicted, the AC to DC power converter 130 comprises a rectifier.

The electrical system may further comprise at least one DC bus 140 (FIG. 1), which is similarly configured to receive power generated by the generator. The at least one DC bus 140 may be connected to the rectifier 130 to receive DC power. In alternative arrangements the generator 100 may have an untreated multi-phase output which is delivered directly to one or more loads. AC-DC rectification may further occur outside of the generator.

It will be understood that the electric machine 100 may otherwise comprise a motor configured to drive the prime mover 2. In this alternative arrangement, the accessory 150 may be arranged as a battery, or several batteries, configured to deliver power to the conductors of the stator 110. The battery 150 provides DC power to the power converter 130, in this context being a DC to AC power converter. The DC to AC power converter 130 comprises an inverter in this arrangement.

AC power is provided to the windings of the stator 110 through the inverter 130. The alternating current provided to the windings produces a time-varying magnetic field which causes the rotor 101 to rotate. This rotates the shaft arrangement 3 and in turn rotates the prime mover 2. In such arrangements, the prime mover 2 may comprise a ducted fan, or may comprise a turbine, for which the electric machine is used as a starter motor or as a starter-generator.

Turning to FIG. 2, there is illustrated a wiring arrangement for the stator 110 included in the electrical system 10 according to FIG. 1.

Electrical machines can be provided with a means of detecting a fault in the machine or its components. A particularly relevant fault is a short-circuit, which occurs when current flows down an unintended path with little to no electrical resistance.

On the other hand, phase-to-phase short circuits in known systems can be addressed by turning off or disconnecting any mechanical input to the machine if acting as a generator, or turning off electrical input if acting as a motor. Thus, known solutions tend to interrupt current flow through all channels of the electrical machine. These solutions therefore prevent further operation of the entire electric machine. This prevents the propagation of faults between channels, as is desirable, however channels which are free of fault are also taken out of operation in the process.

Alternatively, electrical systems may include the use of a switch coupled to an output of the generator, being operable to electrically isolate the windings. This provides an arrangement which can be reset without dis-assembly of the generator. However, such arrangements do not usually have a reliable sensing means, to detect faults, or may even experience re-closure; particularly in applications which are subject to dynamic forces of large magnitudes, which can occur in aircraft, or more particularly eVTOL aircraft.

In FIG. 2, it can be seen that the stator 110 comprises a plurality of windings 123A, 123B and 123C. These windings each belong to a separate phase (A, B and C) and are each separated from adjacent windings of differing phases by 120 degrees. It will be appreciated by the person skilled in the art that this example is simplified, and that each phase may comprise a plurality of sets or subsets of windings. Similarly, while the stator 110 comprises three phases in the illustrated example, it may generally comprise any plurality of phases such as two or more phases, although three phases are often used.

Each winding 123A, 123B, 123C comprises a first end 121 connected to a common neutral conductor, or ‘star point’, 126. A common neutral is typically referred to as a star point, since electrical diagrams typically show it as a central connection point between phases radiating from the star point, and so this logical terminology can be used for that point. The electrical machines according to the present disclosure may comprise a plurality of star points. The or each common neutral conductor or star point 126 is configured to comprise a net current of zero in ordinary use as, at any time, the current within the common neutral point is the sum of the currents within the windings connected to it. In the illustration of FIG. 2, the neutral conductor 126 is configured as a busbar.

As can be seen, the connection between the first end 121 of each of the windings 123A, 123B, 123C and the common neutral 126 comprises a sensing means 124A, 124B, 124C. Since the purpose of the sensing means is to sense a current in the conductor, it can in some arrangements be placed at any position along the conductor or windings to detect the current flowing in the windings. The connection between the first end 121 of each of the windings 123A, 123B, 123C and the common neutral 126 further comprises an electrical interrupter 125A, 1255, 125C.

The interrupter 125A, 125B, 125C associated with each phase is configured to electrically disconnect the windings 123A, 1235, 123C from the neutral conductor 126 when operated. Such operation may be instigated directly or via a control system when the sensing means 124A, 1245, 124C detects an electrical fault.

Each winding 123A, 1235, 123C further comprises a second end 122 connected to an external power input or output, via the optional power converter 130. The connection between the second end 122 of each of the windings 123A, 1235, 123C and the external power input or output, via the optional power converter 130 may comprise a sensing means 127A, 1275, 127C. The connection between the second end 122 of each of the windings 123A, 123B, 123C and the power converter may further comprise an electrical interrupter 128A, 128B, 128C. It will be understood that the inclusion of a second measuring means and/or a second interrupter is optional. It is also possible to supply a single measuring means to both the first end 121 and the second end 122 of each respective winding, configured to compare a property of one to the other.

Herein discussed without reference to a specific phase (A, B or C), the person skilled in the art will understand that the reference numerals of FIG. 2 may apply to any of phases A-C.

With the configuration illustrated in FIG. 2, each phase A, B, C of the windings 123 which may be subject to a fault in operation of the stator 110 may be individually disconnected in such an event. For example, if a fault were detected in phase A by the sensing means 124A, 127A, the electrical interrupters 125A, 128A may disconnect the winding 123A from the electrical circuit. By interrupting the connection at the first end, between the winding 123 and the neutral conductor 126, the phase in question is isolated from the other phases, which can allow them to continue operation without negative impact from the faulty disconnected phase. By interrupting the connection of any phase A, B, C at the second end, between the winding 123 and the external power input or output, and the optional power converter 130, the connection of said phase is opened. This inhibits the flow of further current through that phase to the external power input or output, or the optional power converter 130, isolating connected components from any residual voltage variations created by the faulty phase windings. Beneficially, this configuration can also protect the external power converter 130 which is advantageous within an aircraft as there is no need for a further protection means. This results in increased weight saving.

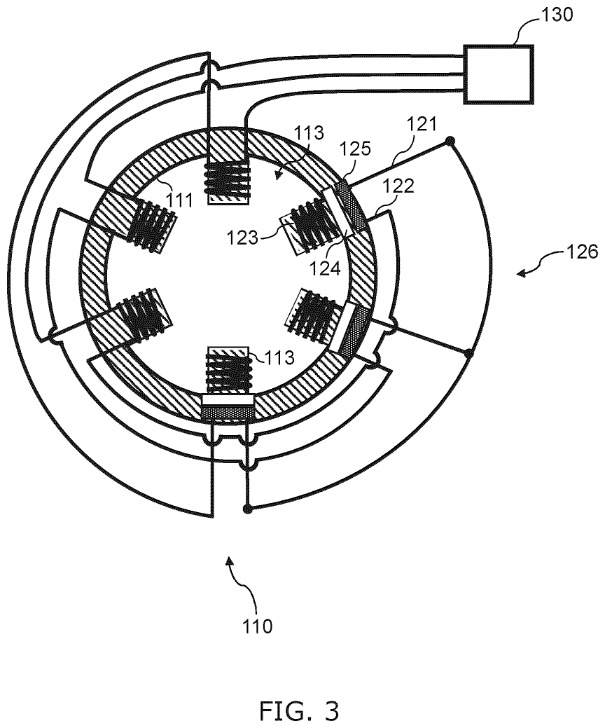

FIG. 3 illustrates a schematic representation of a stator assembly comprising the electrical configuration of FIG. 2. It will be appreciated by the person skilled in the art that the stator 110 comprises three phases in the illustration. The stator 110 may comprise two phases, or four our more phases. It will also be appreciated that the principles which apply to the annotated phase applies similarly to the unannotated phases.

The stator 110 comprises an annular body 111. The annular body 111 generally defines a bore 113 therein, configured to receive a rotor assembly (not shown). The stator 110 illustrated comprises a plurality of teeth 113 which extend radially inward from an inner circumference of the annular stator body 111.

In certain arrangements, the overall assembly of the stator 110 may comprise a plurality of discrete stators each arranged to comprise a portion of the plurality of teeth 113. For example, the assembly of the stator 110 may comprise three mechanically discrete stators, each corresponding to an individual star. This provides increased redundancy as, should one star have a fault, stars without fault may continue to operate without interruption.

Though the stator body 111 is schematically depicted showing windings resembling a wire conductor 123 wound on teeth 113 of the stator body 111, stators may alternatively be formed with a stator body comprising slots in which pre-formed conductors are inserted. This can allow the conductors, which are analogous to the windings of the illustration, to be produced with additive manufacturing methods.

In the illustration of FIG. 3, both the first end 121 and the second end 122 of at least one winding 123 of any phase A, B, C is measured with a single sensing means 124. In this embodiment, a single electrical interrupter 125 is also disposed across both the first end 121 and the second end 122 of a single winding 123. With this arrangement, when the sensing means 124 detects a fault, either by sensing an unexpected property such as voltage or current at either or both of the first and second ends of the windings, the electrical interrupter 125 can be operated to interrupt the electrical connection of the winding 123 at both the first end 121 and the second end 122 simultaneously. It will be understood that “simultaneously” describes actions which occur at the same time. In this context, the term refers to the electrical interruption of both the first end 121 and the second end 122 of a winding 123 occurring as a result of a single fault. This disconnects the associated phase from the electrical circuit and inhibits the fault of a short circuit within the associated winding from propagating.

The electrical interrupter 125 may be configured to comprise a sacrificial part. A sacrificial part is a part of a machine or product that is intentionally engineered to fail under excess mechanical stress, electrical stress, or other unexpected and dangerous situations. The sacrificial part is engineered to fail first, and thus protect other parts of the system.

In such configurations, following activation by the sensing means 124, to break the electrical path, the interrupter 125 is rendered inoperative. This reduces the likelihood of unintended re-closure of the circuit. Furthermore, in spite of the disabling of at least one phase of the machine using this feature, the overall electrical machine would continue to operate until all the phases were electrically interrupted. In this way, components may still receive power in the event of a short circuit. In the event of a phase-to-phase short circuit within a star, the phases with faults may be interrupted by breaking the associated neutral connections. This isolates the fault and stops the associated star from functioning due to the break between the phases of the star at the neutral point. Advantageously, any other unaffected stars in the machine may still continue to function, for example continuing to provide power to the output of the windings in those stars.

The electrical interrupter 125 may be configured to mechanically break the circuit in response to an electrical signal. The electrical interrupter 125 may be configured to mechanically sever the connection at any of the first end 121 and the second end 122 of the winding 123. In such embodiments, the interrupter 125 may physically cut, sever or break the cable or wire at either end of the winding 123. The interrupter may comprise a conductive element forming part of the electrical circuit and a device configured to sever the conductive element in response to an electrical signal. The interruption may also be created by a cutting or shearing mechanism. A mechanical separation of a sacrificial element provides a relatively lightweight means of achieving an arrangement which reduces the likelihood of unintended re-closure of the circuit.

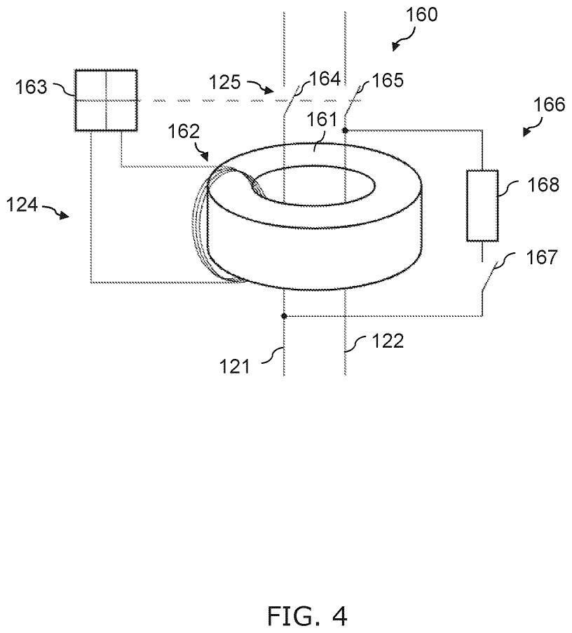

FIG. 4 illustrates an example of a control arrangement for operating a sensing means 124 and an electrical interrupter 125 suitable for use in the stator assembly of FIG. 3. The sensing means 124 may be provided in the form of a current transformer coil 160.

In the arrangement shown, both the first end 121 and the second end 122 of a single winding 123 are passed through an annular ferromagnetic core 161. Each of the first end 121 and the second end 122 of the winding 123 may be provided with selectively controllable contacts 164, 165. These may take the form of the electrical interrupters disclosed above. The transformer coil 160 comprises a coil winding 162 wound around the core 161. The output of the winding 162 can be connected to a controller 163. The illustrated arrangement depicts a sensing means 124 comprising the secondary winding 162, an electrical interrupter 125 and a controller 163 arranged to actuate the electrical interrupter to break the circuit at break points 164, 165.

During normal operation, the vector sum of the currents flowing through the transformer 160 is zero as the currents flowing through the first end 121 and the second end 122 of the winding 123 are equal in magnitude and opposed in direction. In this condition, the coil winding 162 of the transformer coil 160 induces no output, and thus the break points 164, 165 remain unbroken.

If a fault occurs in the winding 123, a non-zero net current is sensed by the transformer coil 160. As a result, a current or voltage is induced in the coil winding 162. This in turn allows a current or voltage to flow to the controller 163 which can activate the electrical interrupter 125 to open the circuit at break points 164, 165, and disconnect the winding 123 from both the neutral conductor 126 and the output of the stator 110. Advantageously, such a configuration is very sensitive to changes in current, providing a more reliable sensing means.

There may also be provided an external activation means 166 for externally activating the electrical interrupter 125 with an external input. The external activation means 166 may comprise a switch, transistor, or other selectively controllable contact 167. During normal operation, the selectively controllable contact 167 is open. The external activation means 166 may also comprise a resistor 168. The manual activation means 166 connects the first end 121 of the winding 123 to the second end 122 of the winding 123 and the selectively controllable contact 167 and the resistor 168 are connected in series with one another therebetween. By closing the selectively controllable contact 167, the current through the first end 121 of the winding is decreased by the resistor 168 and in turn causes a non-zero current in the secondary winding 162. This can activate the controller to break the circuit at break points 164, 165. This provides an external means for triggering the electrical interrupter 125 in the event that an event external to the control arrangement causes need for a winding to be deactivated, such as a fault condition external to the windings of the stator requiring them to be disconnected.

In an alternative arrangement, the controller may be an electromagnet configured to disengage movable contacts located at the break points 164, 165 by direct control means, for example by mechanical connection between an electromagnet and mechanical switches at the break points 164 and 165.

It will be appreciated that some or all of the control arrangement or controller 163 may be located externally to or remotely from the electric machine or within the electric machine.

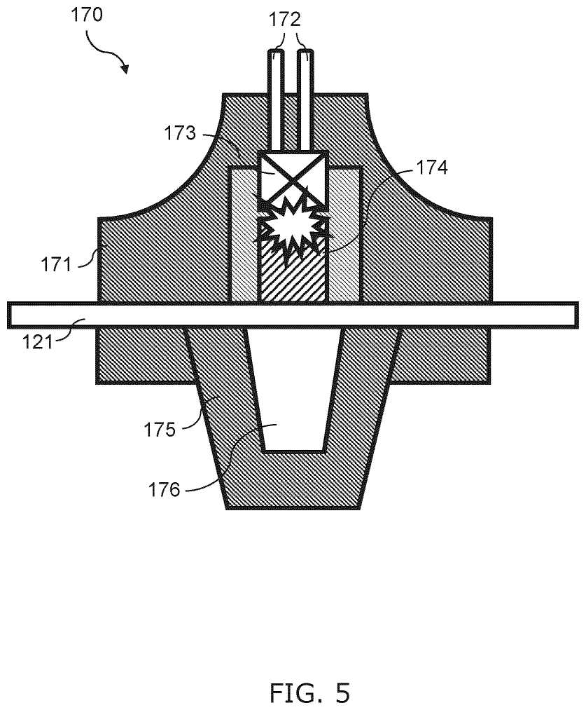

FIG. 5 illustrates an example of a sacrificial part 170 which may be used as an electrical interrupter in the generator 10. The component is configured to mechanically break the circuit in response to an electrical signal and in this respect can be considered electro-mechanical. The part 170 generally comprises an upper housing 171 having electric conductors 172. The conductors 172 are electrically connected to an initiator 173, which is configured to ignite when a sufficient current is received from the prongs 172. The part 170 also further comprises a lower housing 175, and at least one current conductor to be severed—in this example, the first end 121 of a winding 123—can be received between the upper housing 171 and the lower housing 175. Alternatively, the part 170 may comprise a conductor arranged to be connected in series with the conductor to be disconnected. Such a conductor may be severed by the part 170 when it is activated. In this way, to instate the system to working order, the part 170 can be replaced, including a new conductor and a new initiator 173. It will be understood that FIG. 5 is a cross-sectional illustration, and that two or more conductors may be located or received between the upper housing 171 and the lower housing 175.

The initiator 173 may be configured as a gas generator configured to emit gas. Thus, when ignited upon the supply of a sufficient current from the prongs 172, the initiator 173 may emit a gas, for example by explosive action, which exerts a pressure within the upper housing 171 of the part 170. Such components can be known as pyro-fuses, which act to break a circuit by pyrotechnic effect.

The initiator 173 is generally disposed adjacent to a piston 174 which is configured to be moveable in the axial direction with respect to the initiator 173. The piston 174 may be a metallic bar. Upon ignition of the initiator 173, the piston 174 is moved axially towards the lower housing 175 under the pressure of the gas emitted by the initiator 173. In motion, the piston 174 severs the conductor 121 such that it is fractured. The fractured portion of the conductor 121 is deposited in a chamber 176 formed in the lower housing 175 of the part 170.

Various modifications, whether by way of addition, deletion and/or substitution, may be made to all of the above-described embodiments to provide further embodiments, any and/or all of which are intended to be encompassed by the appended claims.

1. A multi-phase electrical machine for use in an aircraft, the electrical machine comprising:
a stator comprising a plurality of electrical phases, each of the electrical phases comprising phase windings, the phase windings in each of the phases including a first end electrically connected to a common neutral conductor, and a second end providing an electrical connection from the phase winding to an electrical power source or load;
a rotor comprising an array of magnetic elements, the rotor being rotatably mounted with respect to the stator;
sensing means configured to sense a condition of the stator indicative of an electrical fault in one of the plurality of electrical phases; and
at least one electrical interrupter operable to electrically disconnect at least one of the first ends of the plurality of phase windings from the common neutral conductor,
wherein the at least one electrical interrupter is operable such that the electrical interrupter can both:
electrically disconnect at least one of the first ends of the plurality of phase windings from the common neutral conductor; and
electrically disconnect at least one of the second ends of the plurality of phase windings from an external input or output of the electrical machine.

2. The electrical machine of claim 1, the fault detection means and the at least one electrical interrupter being connected to a control arrangement, the control arrangement being configured to operate the at least one electrical interrupter upon sensing of a fault in one of the plurality of electrical phases by the sensing means.

3. The electrical machine of claim 1, wherein the at least one electrical interrupter is an electromechanical device configured to mechanically break the circuit in response to an electrical signal.

4. The electrical machine of claim 1, wherein the at least one electrical interrupter comprises a sacrificial part.

5. The electrical machine of claim 1, wherein each of the phases of the electrical machine comprises at least one electrical interrupter.

6. The electrical machine of claim 1, further comprising a plurality of electrical interrupters arranged such that the windings of each of the phases can be disconnected from both the common neutral conductor and the electrical input or output of the electrical machine independently of the other phases.

7. The electrical machine of claim 1, the at least one electrical interrupter including at least one first electrical interrupter and at least one second electrical interrupter, wherein the at least one first electrical interrupter is configured to electrically disconnect at least one of the first ends of the windings in at least one of the phases from the common neutral conductor, and the at least one second electrical interrupter is configured to disconnect at least one of the second ends of the windings in at least one of the phases from the electrical input or output of the electrical machine.

8. The electrical machine of claim 1, wherein the at least one electrical interrupter is configured to simultaneously electrically disconnect at least one of the first ends of the windings in the at least one phase from the common neutral conductor, and at least one of the second ends of the windings in the at least one phase from the electrical input or output of the electrical machine.

9. The electrical machine of claim 1, wherein the sensing means is configured to detect a difference in current between the first end and the second end of the windings in one of the phases.

10. The electrical machine of claim 9, wherein the sensing means comprises a current transformer.

11. The electrical machine of claim 1, wherein the stator comprises a plurality of mechanically discrete stator sections, each of the mechanically discrete stator sections including at least one winding.

12. The electrical machine of claim 11, wherein each of the mechanically discrete stator sections comprises windings of a single star.

13. An aircraft comprising the electrical machine according to claim 1.

14. The electrical machine of claim 9, wherein the electrical interrupter comprises a current transformer.

15. The electrical machine of claim 9, wherein the sensing means and the electrical interrupter comprises a current transformer.
